(19) United States
(12) Patent Application Publication
(10) Pub. No.: US 2005/0028306 A1
(43) Pub. Date: Feb. 10, 2005

(54) Apparatus and bit for cleaning pipes

(75) Inventor: Scott T. Bergstrom, Roscoe, IL (US)

Correspondence Address: LEYDIG VOIT & MAYER, LTD, 6815 WEAVER ROAD, ROCKFORD, IL, 61114-8018, US

(73) Assignee: Bergstrom Skegs, Inc., Machesney Park, IL (US)

(21) Appl. No.: 10/634,549

(22) Filed: Aug. 5, 2003

(51) Int. Cl. B08B 9/045

(52) U.S. Cl. 15/104.31; 15/104.14

(57) ABSTRACT

A rotary cutter and end bit therefore is provided for cleaning and clearing debris and roots from a pipe. The cutter comprises a support housing having a plurality of radially extending skid fins, which help position the chain root cutter in the center of the pipe. The support housing carries a rotor and the rotor rotates relative thereto. A motor supported by the support housing is adapted to rotate the rotor. A plurality of linkages extends radially from the rotor and attaches at least one end bit to the rotor of the chain root cutter. The end bit comprises a hard wear resistant material, such as carbide, that faces radially outward and increases the wear life of the end bit. The wear resistant material may comprise carbide chips that continuously provide sharp edges over the life of the end bit.

### FIELD OF THE INVENTION

This invention pertains to an apparatus for cleaning and clearing debris from pipes. More particular, the invention is directed toward rotary cutters that remove blockages and debris from pipes and a method for improving the operation of rotary cutters.

### BACKGROUND OF THE INVENTION

A major area of maintenance associated with water supply pipes, sewer pipes or other pipelines is maintaining the flow of fluid through the pipes by preventing blockages. For example, over the lifespan of a sewer pipe, the flow through a sewer pipe is restricted by numerous blockages within the pipe, including roots and material deposits, such as grease, lime, crusts and scales. Removal of blockages has been accomplished by the use of apparatus often known as “chain root cutters” such as those commercially available from Cloverleaf Tool Company of Sarasota, Fla., and shown and described in literature entitled Pipeline/Sewer Clearing & Maintenance Equipment available therefrom. As provided in the Chain Root Cutter model set forth therein, chain root cutters are typically centered in pipes using skid fins and/or water jets. Steel chains, as in the Chain Root Cutter model, attached to the chain root cutter are rotated to centrifugally cut and grind away the blockages. The chains are rotated by a motor, which is typically a water driven motor or nozzle. Alternatively, the chains are replaced with a relatively rigid cable linkage. A problem with chain root cutters, which will be appreciated once the present invention is understood, is that the chains are not particularly sharp and have a limited wear life. By failing to provide sharp edges, the chains tend to pulverize the roots rather than cutting and removing them. A problem with rigid cable versions is that the cable frays, reducing the rigidity of the cable which significantly reduces its cleaning ability.

### BRIEF SUMMARY OF THE INVENTION

It is a general aspect of the present invention to provide a rotary cutter which provides an increased wear life.

It is a further aspect of the present invention to provide a rotary cutter that more effectively removes debris and blockages from pipes.

In accomplishing its aims and objectives, the disclosed invention provides a rotary cutter, comprising a support housing having a plurality of radially extending skid fins, which help position the rotor cutter in the center of the pipe. The support housing carries a rotor, and the rotor rotates relative thereto. A motor also carried by the support housing is adapted to rotate the rotor. A plurality of linkages extend radially from the rotor and attach at least one end bit to the rotor. The end bit comprising a hard wear resistant material that faces radially outward and increases the wear life of the end bit. According to a preferred embodiment, the hard wear resistant material comprises carbide chips that provide sharp edges adapted to engage and dislodge debris and roots within the pipe more effectively. The carbide chips provide the sharp edges throughout the life of the end bit.

It is a further aspect according to a preferred embodiment that the end bit is self-sharpening. The end bit is self sharpening because new carbide chips are uncovered to provide new sharp edges as the carbide chips on the outer surface wear or break.

The present invention also provides a method for improving the operation of a rotary cutter for use in cleaning pipes. The method includes providing an end bit to a rotary cutter. The cutter comprises a support housing, radially extending skid fins, a rotor and a motor for rotating the rotor. The method comprises providing a surface engaging end bit comprising a plurality of chips of a wear resistant material, and linking the end bit to the rotor of the cutter with a linkage.

These and other objects and advantages of the invention, as well as additional inventive features, will be apparent from the description of the invention provided herein.

### BRIEF DESCRIPTION OF THE DRAWINGS

FIG. 1 is an isometric illustration showing a chain root cutter, including an end bit pursuant to the disclosed invention, inserted in a pipe.

FIG. 2 is an isometric illustration of an alternative embodiment of the end bit of FIG. 1 having a chain link support structure.

FIG. 3 is an isometric illustration of an alternative embodiment of the end bit of FIG. 1 having an angle iron support structure.

FIG. 4 is an expanded isometric illustration of the end bit of FIG. 1.

FIG. 5 is an expanded isometric illustration of an alternate embodiment of the end bit of FIG. 1.

FIG. 6 is an enlarged cross-sectional illustration taken generally along the line 6-6 of FIG. 3.

### DETAILED DESCRIPTION OF THE INVENTION

The following disclosed embodiments further illustrate the invention, but of course, should not be construed as in any way limiting its scope.

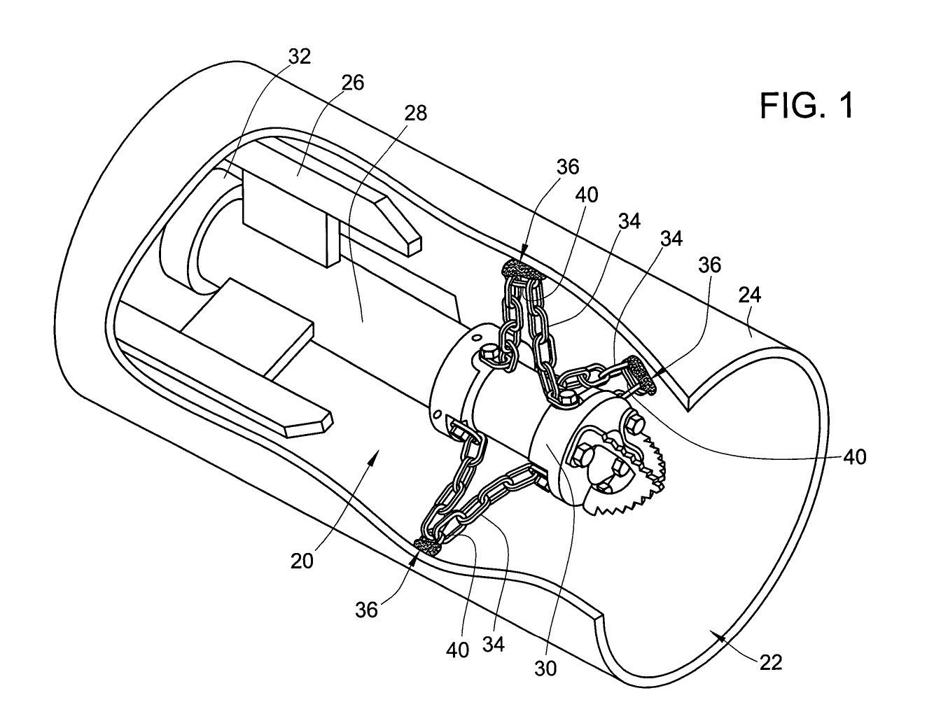

Referring to FIG. 1, a rotary cutter in the form of a chain root cutter 20 for cleaning and clearing debris from the inside channel 22 of a cylindrical pipe 24 or other suitable structure is illustrated. The chain root cutter 20 removes debris such as roots, grease, scales, lime, sludge, or the like, while moving generally in an axial direction along the cylindrical pipe 24. The chain root cutter 20 includes skid fins 26, attached to a support housing 28, to help center the chain root cutter 20 in the cylindrical pipe 24. The skid fins 26 extend radially outward from the support housing 28 defining an outer periphery. The skid fins 26 generally help center the chain root cutter 20 in the pipe because the diameter of the defined outer periphery is slightly smaller than the inside diameter of the pipe that is being cleaned and traversed. Furthermore, the skid fins 26 are adapted to facilitate traversing ridges or other impediments that may be present in the pipe, particularly where sections of pipe come together.

A rotor 30 is carried by and rotates relative to the support housing 28. The support housing 28 is generally angularly stationary within the pipe 24. The rotor 30 is positioned such that it is generally centered about the central axis of the pipe 24. Adapted to rotate the rotor 30 and propel the chain root cutter 20, a motor 32 or other rotation device, which may include but is not limited a water driven motor, a rotating water driven nozzle, or the like, is also carried by the support housing 28. High pressure water jets in the motor 32 propel the chain root cutter 20 through the pipe 24. The force provided by the water jets assist the skid fins by facilitating centering the chain root cutter 20 within the pipe 24.

A plurality of linkages 34, which may include chains (as illustrated in FIGS. 1-5 which comprise a plurality of individual chain links), cable, hinged rigid strips of metal, flexible strips of metal, or the like, are removably attached to the rotor 30. The linkages 34 attach end bits 36 to the chain root cutter. The linkages 34 are adapted such that the centrifugal force created by the spinning or rotating of the rotor 30 extends the linkages 34 radially outward from the rotor 30. The lengths of the linkages 34 are determined such that the attached end bits 36 extend slightly beyond the outer periphery defined by the skid fins 26. Thus, the chain root cutter 20 can be adapted to be used in pipes of different diameter by changing the length of the linkages 34, more particularly by changing the length of the linkages 34 that extends radially outward as the linkages 34 are extended by way of centrifugal force.

The end bits 36 attached to the plurality of linkages 34 increase the durability, wear resistance and cleaning ability of the chain root cutter 20. The end bits 36 are adapted to face radially outward as the rotor 30 rotates, thereby extending the linkages 34 radially outward by way of centrifugal force. Having the end bits 36 facing radially outward allows the chain root cutter 20 to present the end bits 36 to the inner surface of the cylindrical pipe 24 to more effectively contact and remove material deposits and roots from the pipe 24.

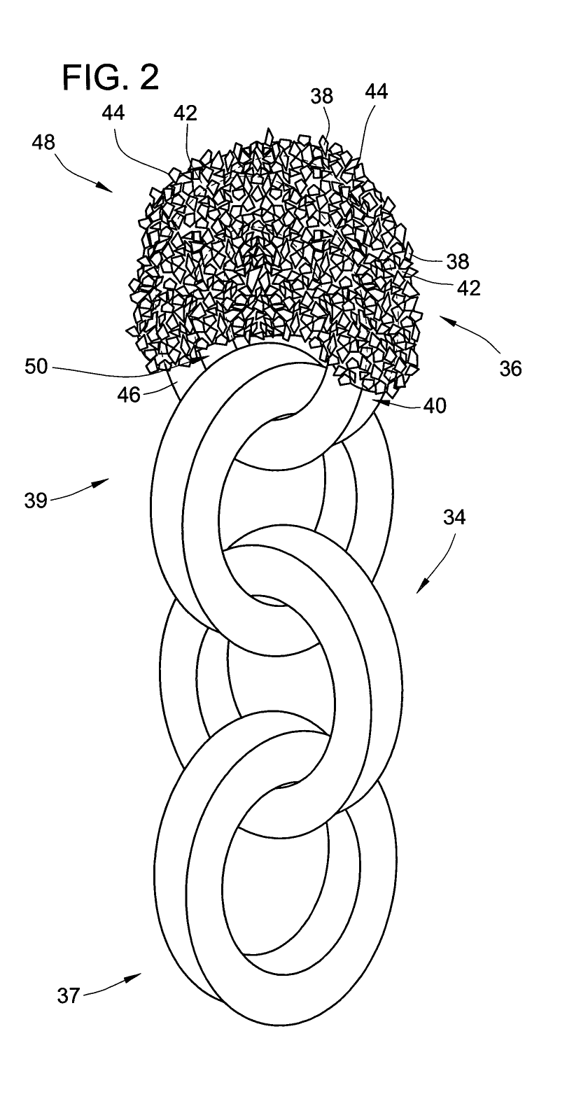

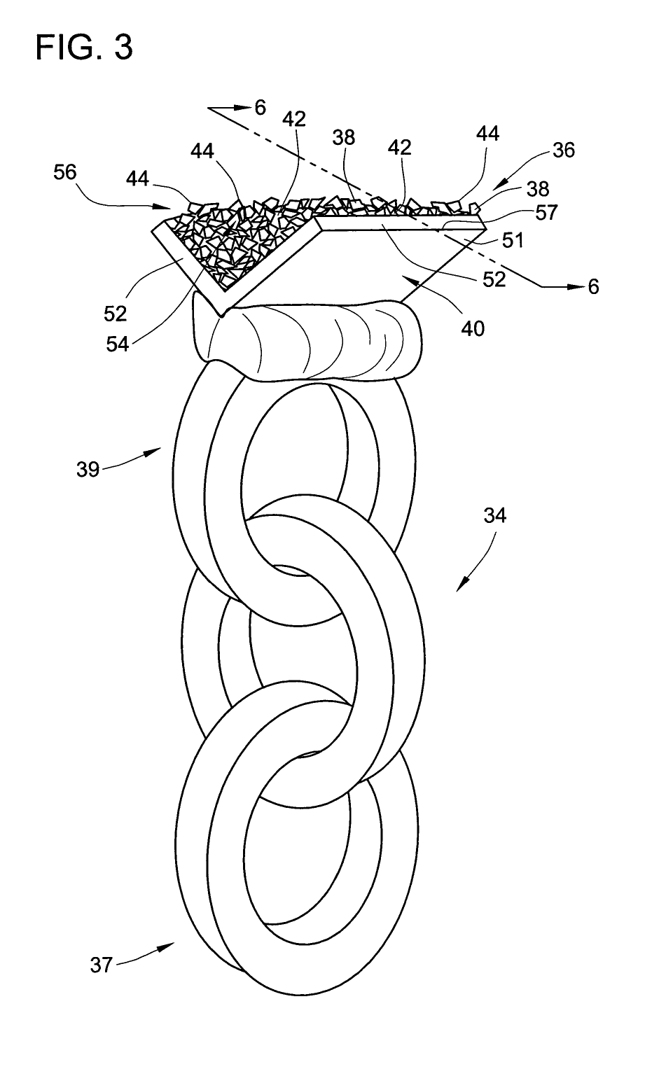

FIGS. 2 and 3 illustrate alternate embodiments of the linkage 34 of FIG. 1 that have a first end 37 of the linkage 34 adapted to mount the linkage 34 to the rotor 30 (FIG. 1). The linkages 34 have a second opposite end 39 having an end bit 36 attached thereto.

FIG. 2 illustrates a preferred embodiment of the end bit 36 attached to a linkage 34. The illustrated end bit 36 comprises carbide chips 38 integrally attached to a support structure 40 using solder 42 suitable for soldering carbide material using conventional solder/brazing techniques. The solder 42 and carbide chips 38 defining a surface engaging mass. Preferably, the mean maximum dimensional size of the carbide chips 38 is less than 6 millimeters, and more preferably, the mean maximum dimensional size of the carbide chips 38 is between about 1 and 3 millimeters. Smaller carbide chips present a flatter less aggressive profile, one that sill no penetrate the pipe walls. Larger carbide chips present a more aggressive profile which in some circumstances would be advantageous, such as when there is severe blockage problems. The carbide chips increase the wear resistance of the end bit 36, thereby increasing the lifespan and the interval between replacements of the end bit 36. Also, the carbide chips 38 provide sharp jagged edges 44, which increase the cutting and engaging action of the end bits 36 increasing the ability to remove roots and dislodge debris from the pipe.

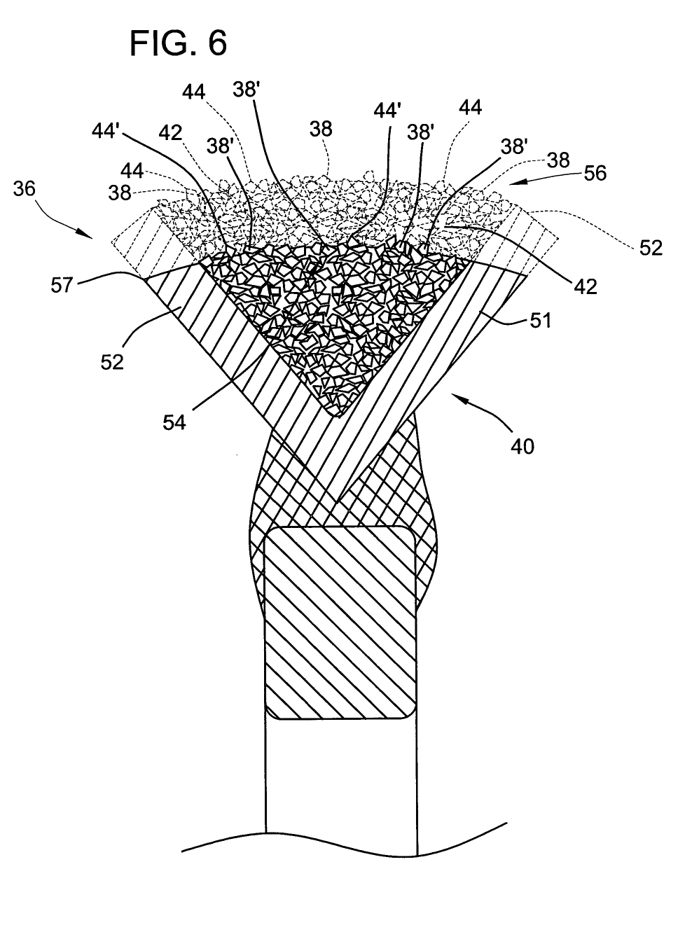

The cross-sectional view of an end bit 36 in FIG. 6 illustrates that the end bits are self-sharpening. As the outer sharp jagged edges 44 are rounded or worn away (indicated by the dashed lines), new sharp edges 44′ of previously hidden and unused carbide chips 38′ (indicated by solid lines) become exposed, thereby maintaining the outer surface engaging face sharp, not only at the beginning but, throughout the life of the end bit 36. As seen, the carbide chips 38 and 38′ are distributed throughout the entire volume of the carbide and solder surface engaging mass and not located only at the outer periphery.

As illustrated in FIG. 2, a preferred support structure 40 for the end bit 36 comprises a steel chain link 46. The support structure 40 is attached to the linkage 34. Having a chain link 46 support structure 40 provides significant surface area for the solder 42 to bond the carbide chips 38 to the end bit 36. Furthermore, the soldered carbide chips 38 substantially surround the chain link 46, thereby, defining a surface engaging mass in the form of a clump/ball 48 comprising carbide chips 38 and solder 42. As the clump/ball 48 tends to form around the chain link 46, as well as within the inner channel 50 of the chain link 46, the clump/ball 48 more securely attaches to the support structure 40. Furthermore, as a result of the clump/ball 48 forming substantially around the chain link 46 support structure 40, the support structure 40 does not create interference between the carbide chips 38 and the debris that is being removed and dislodged from the pipe.

FIG. 3 illustrates an alternative embodiment of the end bit 36 in accordance with the disclosed invention. In this embodiment, the support structure 40 comprises a segment of steel angle iron 51 integrally attached to the linkage 34, typically by welding. The angle iron 51 defines a v-shaped trough 52 that includes a channel 54 in which the carbide chips 38 are soldered. The “v-shape” of channel 54 of the angle iron 51 is used to reduce weight of the end bit 36. However, for chain root cutters having stronger motors, alternative embodiments of the support structure 40 forming rounded channels or square channels are preferred because the amount of carbide chips that can be soldered in the channel is increased. Instead of a clump/ball being formed substantially around the support structure 40, in this embodiment, the carbide chips 38 and solder 42 form a radially outward facing surface engaging mass in the form of a slightly mounded surface 56 of carbide chips 38 and solder 42. While the rotor turns and centrifugally extends the linkage 34 and end bit 36 radially, the slightly mounded surface 56 faces radially outward such that the end bit 36 presents the carbide chips 38 to the inner surface of a pipe or to remove debris within the pipe. Furthermore, the angle iron provides a sharp edge 57 to facilitate cutting roots and dislodging debris.

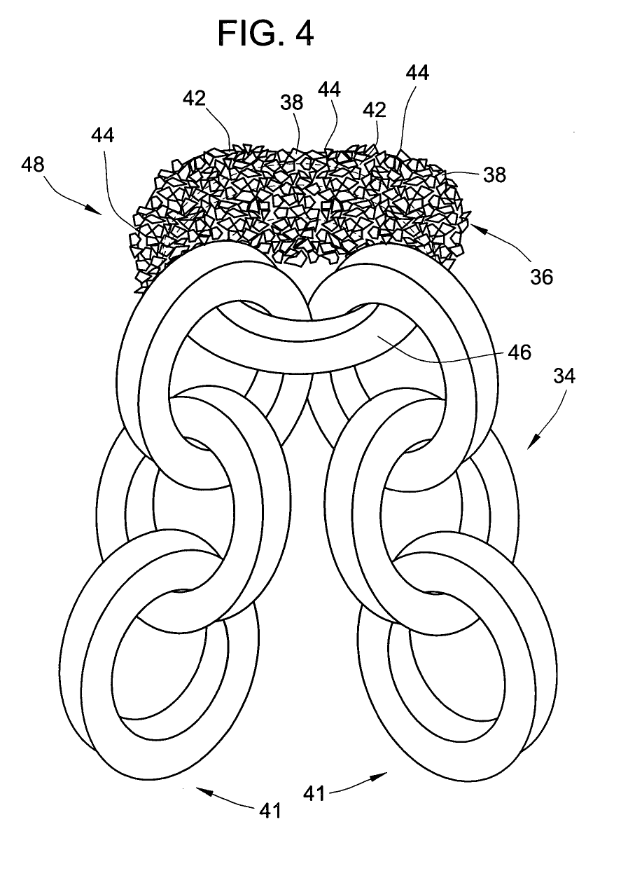

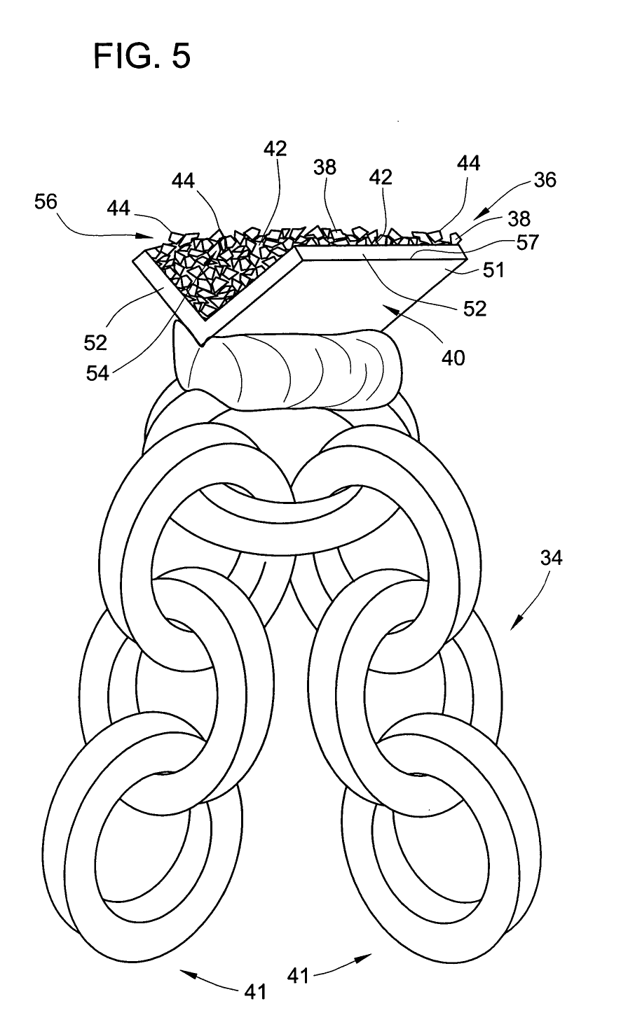

FIGS. 4 and 5 illustrate alternate configurations of end bits attached to linkages. The end bits of these configurations are similar to and have most of the features of the end bits in FIGS. 2 and 3, respectively. However, the end bits 36 are attached to linkages 34 comprising multiple ends 41 adapted to mount the linkages 34 to a rotor 30 (FIG. 1). The end bit 36 attaches between the multiple ends 41. However, still considered the “end bit” because it extends radially outward to the radial boundary or “end” under centrifugal action. These embodiments require more linkage material than the previous embodiments. However, these embodiments are stronger and provide a double redundancy by generally having two linkages attaching the end bit 36 to the rotor 30.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A rotary cutter for use in cleaning pipes, comprising:
a support housing having a plurality of skid fins extending radially outward therefrom at different angular positions about the support housing defining a radial periphery;
a rotor carried by the support housing which rotates relative thereto;
a motor supported by the support housing adapted to rotate the rotor;
a plurality of linkages mounted to the rotor extending radially outward therefrom, the linkages being made of a first material; and
at least one end bit comprising a surface engaging mass that comprises a second material that is harder than the first material, the at least one end bit being attached to the chain root cutter by at least one of the plurality of linkages, the at least one end bit centrifugally extending beyond the radial periphery when rotated.

2. The rotary cutter of claim 1 wherein, said at least one end bit further comprises a support structure, the support structure adapted to attach the end bit to said linkages and said second material is soldered to the support structure.

3. The rotary cutter of claim 1, wherein said plurality of linkages comprises chains.

4. The rotary cutter of claim 2, wherein said support structure comprises a chain link.

5. The rotary cutter of claim 2, wherein said support structure comprises a channeled member secured to the linkage.

6. The rotary cutter of claim 2, wherein said second material comprises carbide in the form of a plurality of carbide chips soldered together.

7. The rotary cutter of claim 6, wherein said carbide chips have a mean maximum dimensional size of less than about 6 millimeters.

8. The rotary cutter of claim 6, wherein said carbide chips have a mean maximum dimensional size of between about 1 millimeters and about 3 millimeters.

9. An end bit for a rotary cutter for use in cleaning pipes, comprising:
a support structure of a first metal material for attaching the end bit to a rotor of a rotary cutter;
a plurality of carbide chips; and
solder material securing the carbide chips together in a surface engaging mass and securing the carbide chips to the support structure.

10. The end bit of claim 9, further comprising a linkage for attaching the end bit to a rotor of a rotary cutter, having said support structure attached thereto.

11. The end bit of claim 10, wherein said support structure is welded to said linkage.

12. The end bit of claim 10, wherein said linkage comprises a chain.

13. The end bit of claim 9, wherein said carbide chips have a mean maximum dimensional size of less than about 6 millimeters.

14. The end bit of claim 9, wherein said carbide chips have a mean maximum dimensional size between about 1 and about 3 millimeters.

15. The end bit of claim 9, wherein said support structure comprises a chain link.

16. The end bit of claim 9, wherein said support structure comprises a channeled member.

17. A method for improving the operation of a rotary cutter for use in cleaning pipes, the rotary cutter comprising a support housing having a plurality of skid fins extending radially outward therefrom at different angular positions, a rotor carried by the support housing for rotation relative thereto, the rotor adapted to carry a plurality of linkages, and a motor supported by the support housing adapted to rotate the rotor, the method comprising:
providing an end bit comprising a plurality of chips secured together on a support structure, the chips being of a first material harder than the support structure; and
linking the end bit to the rotor with one of the linkages, wherein the plurality of chips provide a surface engaging mass facing radially outward and a away from the rotor during rotation of the rotor.

18. The method for improving the operation of the rotary cutter of claim 17, wherein said providing comprises soldering said chips to said support structure.

19. The method for improving the operation of the rotary cutter of claim 18, wherein said support structure is a chain link.

20. The method for improving the operation of the rotary cutter of claim 18, wherein said support structure comprises a channeled member.

21. The method for improving the operation of the rotary cutter of claim 17, wherein said chips comprise carbide.
